(19) United States
(12) Patent Application Publication
(10) Pub. No.: US 2024/0181710 A1
(43) Pub. Date: Jun. 6, 2024

(54) METHOD, APPARATUS AND SYSTEM FOR QUALITY ASSESSMENT OF AN OBJECT PRODUCED BY AT LEAST ONE 3D PRINTER

(71) Applicant: Replique GmbH, Mannheim (DE)

(72) Inventors: Max Siebert, Mannheim (DE); Kumar Samanvaya, Ludwigshafen (DE); Janos Varadi, Mannheim (DE)

(73) Assignee: Replique GmbH, Mannheim (DE)

(21) Appl. No.: 18/556,493

(22) PCT Filed: Apr. 28, 2022
(86) PCT No.: PCT/EP22/61350

§ 371 Date: Oct. 20, 2023

(30) Foreign Application Priority Data
Apr. 28, 2021 (EP) 21170860.7

(51) Int. Cl. B29C 64/386; B33Y 50/00

(52) U.S. Cl. CPC B29C 64/386; B33Y 50/00

(57) ABSTRACT

BASF SE 202490WO01 13 B16999WO ABSTRACT A computer-implemented method (100) for quality assessment of an object (3) produced by at least one 3D printer (1) using 3D printing processes is provided. The method (100) comprises receiving (101) input data, in particular via an input unit (4), of at least one production parameter pertaining to the production of the object (3). It further comprises comparing (102), in particular via a processing unit (5), the received at least one production parameter to at least one predefined demanded production parameter range and determining (103), in particular via the processing unit (5), printing quality based on the degree of agreement between the at least one production parameter and the at least one predefined demanded production parameter range. The quality assessment results of the object (3) are provided (104), in particular via an output unit (6). Further, an apparatus (2) for quality assessment of an object (3) produced by at least one 3D printer (1), a system for providing quality assessment of an object (3) produced by at least one 3D printer (1), a computer program and a computer-readable storage medium are provided. (FIG. 4)

### FIELD OF THE INVENTION

The present invention relates to 3D printing. In particular, the present invention relates to a computer-implemented method for quality assessment of an object produced by at least one 3D printer using 3D printing processes, to a corresponding apparatus, a corresponding system, a computer program and a computer-readable storage medium.

### BACKGROUND OF THE INVENTION

A wide variety of objects can be and is produced using 3D printing technology. Depending on the intended use of said printed objects, a high degree of accuracy, e.g., in terms of dimension and/or material, may be required of the printed objects.

The accuracy of the printed object may be impaired, e.g., by a loss of calibration of the printers, causing the printed parts to no longer meet the required specifications. Since the 3D printing process comprises multiple steps, several possible sources of error may affect the production of an object. Producing objects that meet the required specifications is especially important since the printing of complex parts can take several hours to complete and/or uses a lot of raw material, such that discarding an object that does not meet the required specifications is very costly.

### SUMMARY OF THE INVENTION

It is therefore an object of the present invention to provide a method for quality assessment of an object produced by at least one 3D printer, a corresponding apparatus and a corresponding system.

The object of the present invention is solved by the subject matter of the independent claims, wherein further embodiments are incorporated in the dependent claims.

According to a first aspect of the invention, a computer-implemented method for quality assessment of an object produced by at least one 3D printer using 3D printing processes is provided.

In this context, quality refers in particular to meeting the required specifications of the object, i.e., the accuracy of the printed object. Said specifications may include the dimensions of the object, the material of the object, material properties of the object such as stiffness, mechanical properties of the object and/or optical properties of the object.

An object may be any kind of object that can be produced by a 3D printer, for example components or parts of larger composite objects. The size of said objects may range from a few μm to several meters and the material of said objects may be any kind of material suitable for 3D printing, in particular polymers or metals.

The 3D printing process may be any kind of 3D printing process, in particular material extrusion, particle deposition, light polymerized printing, powder bed printing, laminated object manufacturing, powder fed printing or electron beam fabrication. Examples for possible 3D printing file formats are .STP, IGES, STL, X3D, COLLADA, VRML, OBJ, PLY and AMF. The printing files are the construction plans for the objects to be printed and are translated into a machine file, which may make use of the G-code. The machine file is then used to control the 3D printing process.

The method according to the invention may be performed locally at the 3D printer, by a server of a print farm comprising a plurality of 3D printers or at a remote location. The latter is especially useful for an ordering costumer to assess the quality of the objects that are produced according to his specifications or for the owner of a 3D printing file who permits the use of the file on an on-demand basis. In the latter cases, the 3D printing files may be encrypted and the assessment of the quality may only be possible for the manufacturer of the 3D printing file.

According to the method, input data of at least one production parameter pertaining to the production of the object is received. Receiving said input data is, in particular, performed by an input unit. Said input unit may, e.g., be an interface directly connected to the 3D printer or a network interface receiving the input data via a wired or wireless network connection, e.g., via the internet.

The received at least one production parameter is then compared to at least one predefined demanded production parameter range. Said predefined demanded production parameter range may be defined manually based on parameter ranges known to produce printed objects fulfilling the required specifications. Additionally or alternatively, the predefined demanded production parameter range may be defined by machine learning techniques, in particular with a self-improving machine learning system. The input data for the machine learning may be a set of production parameters along with measured specifications of the objects produced with said production parameters and may be provided by a database or via a user interface. The data-driven machine learning model may then be parametrized according to a training dataset, the training dataset being based on sets of said input data and the corresponding target parameters. The data-driven machine learning model may then be used to determine a production parameter range. Said determined production parameter range may then be provided to the method for quality assessment, e.g., via a communication interface. The predefined demanded production parameter range may also be a higher-dimensional parameter range, taking into account a correlation between certain production parameters. As an example, several different polymers may be used in a material extrusion 3D printing process and for each of said polymers, a different temperature range is required to heat the polymers. Also, the predefined production parameter range may be different for different types of printers. In order to account for this, the data-driven machine learning model may have the printer type as an input parameter and/or different data-driven machine learning models may be used for different printer types.

The comparison of the received at least one production parameter to the at least one predefined demanded production parameter range is, in particular, performed by a processing unit, wherein the processing unit is connected to the input unit.

The printing quality is then determined based on the degree of agreement between the at least one production parameter and the at least one predefined demanded production parameter range. The degree of agreement may be measured on a scale ranging from complete agreement over partial agreement to complete disagreement. As an example, if the predefined demanded production parameter range is 80 to 120 in arbitrary units, complete agreement may be determined if the production parameter is 100, partial agreement may be determined if the production parameter is 120 and complete disagreement may be determined if the production parameter is 150. The printing quality is determined using the degree of agreement between all of the at least one production parameter and all of the predefined demanded production parameter, wherein weights may be assigned to the individual production parameters. As an example, the humidity at the 3D printer may be less important than the type of raw material used, such that the weight assigned to the humidity is smaller than that of the raw material. Another example for an important production parameter is the printing speed for metal filament printing: If the printing speed is too high, the printed object will become porous, leading to a bad mechanical stability. Yet another example for an important production parameter is the existence of disruptions during the printing process: This may lead to misalignments that may impair, e.g., the optical quality. Also, material parameters of polymers or metals may affect the tensile strength, yield strength and elongation at break of the printed object.

The determination of the printing quality is, in particular, also performed by the processing unit, more particularly directly after the comparison of the at least one production parameter to the at least one predefined demanded production parameter. Additionally, the determination of printing quality may be performed by image recognition of images of the printed object.

Finally, the quality assessment results of the object are provided. Providing the quality assessment results may be performed, in particular, while the object is printed. Therefore, measures may be taken before printing of the object is finished, i.e., the measures can be taken before a lot of 3D printer time and/or raw materials have been used. That is, discarding the fully printed object at the end of the printing process is avoided by the method, which saves time, raw materials and cost.

Providing the quality assessment results of the object is in particular performed by an output unit. Said output unit may be a graphical user interface at the 3D printer and may be connected to the processing unit. Alternatively, the output unit may be a network interface, broadcasting the quality assessment results of the object via a wired or wireless connection to a remote location.

According to an embodiment, the method further comprises calibrating the at least one 3D printer based on the provided quality assessment results. The calibration is performed, in particular, by adjusting processing parameters of a control unit of the 3D printer. A calibration of the at least one 3D printer is particularly necessary if the quality assessment results indicate that the required specifications of the object will not be reached. In particular, said calibration may comprise the adjustment of settings of the 3D printer such that, with the adjusted settings, the production parameters take values that indicate a higher quality. In order to perform said calibration of the 3D printer, the dependence of the production parameters on the printer settings have to be known. By calibrating the 3D printer, especially at the beginning of the 3D printing process, a print of an object with inferior quality is avoided and the object can be printed with production parameters that are known to lead to a high printing quality.

According to an embodiment, the method further comprises aborting the production of the object based on the provided quality assessment results. The abortion is performed, in particular, if at least one parameter of the quality assessment results is outside a predetermined range. This is particularly useful if it is determined that the 3D printer cannot be calibrated to achieve the required printing quality. In this case, more severe changes have to be performed to achieve the required printing quality. Aborting the production of the object is also useful if it is determined that the part of the object that has been printed so far is of such inferior quality that a calibration of the 3D printer will not lead to an object of overall acceptable quality. In this case, the part of the object that has been printed so far will be discarded and a new printing process will be started with a calibrated 3D printer.

Hence, depending on the quality assessment results, it may be preferable to either calibrate the 3D printer or abort the production process. In either case, discarding a fully produced object with inferior quality is avoided, saving time, raw materials and cost.

According to an embodiment, the method further comprises inspecting the produced object based on the provided quality assessment results. The inspection is performed, in particular, based on at least one parameter of the quality assessment results in view of whether the at least one parameter is within a predetermined range of that at least one parameter. This may, for example, be useful if the quality assessment results indicate that the quality of the printed object may just fulfill the required specifications. An inspection of the produced object is also performed if the produced object is a test object, specifically produced to assess the printing quality based on the production parameters. Such an inspection of a test object may also be used as a feedback for adjusting the demanded production parameter range, in particular, if the inspection results of the test object disagree with the quality assessment results.

According to an embodiment, the method further comprises automatically rejecting the produced object based on the provided quality assessment results. Such automatic rejection may occur, for example, at the end of the production process, when it is determined that the quality assessment results do not fulfill the required specifications. As another example, the automatic rejection may occur at the loading of the produced object into another production plant for further processing. In both examples, the rejection of the produced object leads to the produced object not being used for further processing, which in turn leads to final (compound) objects that comprise only produced objects that fulfill the required specifications such that the final (compound) objects themselves fulfill certain specifications. The rejected produced objects may then be, e.g., discarded, re-used or recycled.

According to an embodiment, the at least one production parameter is at least one out of a group, the group comprising material parameters, environmental parameters and printing parameters. Material parameters are, e.g., the composition of the raw materials and/or specific material properties of the raw materials such as melting temperature, density, color or stiffness. Environmental parameters may comprise the environmental temperature, the air pressure, humidity and/or atmosphere composition. The environmental parameters may be measured in the printing space, at the location of the 3D printer, in a room where the 3D printer is located and/or in a cabinet where the raw materials are stored. As an example, the temperature at the location of the 3D printer may be important to determine the additional heating required to melt the raw materials but also to determine how long it takes for printed parts to cool off. As another example, the composition of the atmosphere may be important both in the printing space and in the cabinet where the raw materials are stored, since, for example, metals might require a protective atmosphere to prevent oxidation. The printing parameters may comprise the version of the software installed on the printer, the date of the last calibration, the date of the last service, the time, temperatures, e.g., at the printing head, feed speed, adjustment speed, reconstruction speed, retraction way, height of the printing layer and/or density of the printing layer.

According to an embodiment, the at least one production parameter is obtained during print execution. Especially the printing parameters and the environmental parameters in the printing space are most useful when obtained during the print execution since they reflect the current printing process. Additionally or alternatively, the at least one production parameter is obtained before print execution. This is, for example, important for the composition of the atmosphere in the cabinet where the raw materials are stored, since, e.g., oxidation of metals during storage may happen over a longer time if the metal is not stored under a protective atmosphere.

According to an embodiment, the at least one 3D printer is integrated in a print farm. Said print farm comprises a plurality of 3D printers. For printing the object, a 3D printer is chosen from the plurality of 3D printers based on the 3D printer's ability to print the object, in particular with respect to quality, size and/or material. If several of the 3D printers in the print farm are able to print the object, a choice among the 3D printers may be made based on availability, printing speed, cost and/or quality. The method for quality assessment may be performed at every individual of the 3D printers. However, it is preferable to perform the method centrally for all 3D printers of the print farm or remotely for all 3D printers of the print farm. In that case, only one processing unit is required to determine the printing quality and thus overhead is reduced.

According to an embodiment, the object is marked based on the quality assessment results with a unique identifier. Said unique identifier may be a bar code, a QR code or another type of, preferably machine-readable, code. The unique identifier may comprise a serial number such that each object that is printed can be uniquely identified. The unique identifier may be issued only to objects that have been printed with a printing quality meeting the required specifications, which is determined based on the quality assessment results. Then, objects that meet the required printing quality can be easily recognized. Also, the unique identifier may comprise information about the quality assessment results such as a numerical score.

According to an embodiment, the object is connected to its at least one production parameter using the unique identifier. In particular, there may be a database comprising both the unique identifier and the at least one production parameter. Hence, based on the unique identifier with which the object has been marked, the database can be accessed and the at least one production parameter of the object can be retrieved. Said database may comprise, e.g., all of the at least one production parameter for all times of the printing process, i.e., the at least one production parameter as a time series, but it may also comprise just a selection out of the at least one production parameter and/or only a selection of times for which the at least one production parameter is provided, a time average of the at least one production parameter, and/or other characteristics of the at least one production parameter such as a minimum value, a maximum value or a standard deviation. This may be used, e.g., to prove at a later time that the object has been printed with a printing quality meeting the required specifications and even provide the corresponding production parameters. The knowledge about the production parameters may also be used in the case of a failure of the printed object to find the root cause for the failure. It is also possible to use the production parameters stored in the database to perform another quality assessment at a later time or to automatically issue a certificate of conformity for the produced object. Further, additional data may be added to the database, e.g., by user input or via digital interfaces. This addition of additional data may be performed at any time, i.e., before, during and/or after the production of the object.

According to another aspect of the invention, an apparatus for quality assessment of an object produced by at least one 3D printer using 3D printing processes is provided. The apparatus comprises an input unit, a processing unit and an output unit, wherein the input unit, the processing unit and the output unit are configured to carry out the method according to the above description.

In particular, the input unit is configured to receive input data of at least one production parameter pertaining to the production of the object. The input unit may be an interface directly connected to the 3D printer or a network interface receiving the input data via a wired and/or wireless network connection. In the latter case, the input unit may be configured to receive input data from more than one 3D printer. The network connection may be a local network connection within a print farm or the internet. The input unit may further comprise a user interface, allowing a user to choose for which 3D printers and/or which objects the quality assessment shall be performed.

The processing unit comprises, in particular, at least one processor. It may be configured, specifically by programming, to compare the received at least one production parameter to the at least one predefined demanded production parameter range. It may also be configured to determine, specifically to calculate, the printing quality based on the degree of agreement between the at least one production parameter and the at least one predefined demanded production parameter range.

The output unit may be configured to provide the quality assessment results, in particular, while the object is printed. Said output unit may be a graphical user interface, e.g., at the 3D printer, to output the quality assessment results directly to a user. Alternatively, the output unit may be a network interface, adapted to broadcast the quality assessment results of the object via a wired or a wireless connection to a remote location, e.g., to a central data interface.

According to another aspect of the invention, a system for providing quality assessment of an object produced by at least one 3D printer using 3D printing processes is provided. The system comprises an apparatus according to the above description and a web server. The web server is configured to interface with a user and the system is configured to provide a graphical user interface to the user. Said interfacing with the user and providing a graphical user interface to the user may be performed via a webpage served by the web server and/or via an application program. Providing a graphical user interface to a user, in particular a remote user, allows users to assess the quality of objects printed by a 3D printer, regardless of where the user and the 3D printers are located. Hence, a user may assess the quality of the objects printed according to his order and/or his specifications. In particular, the printed objects may then be shipped to a third party without the need of an extra quality control by the user.

According to another aspect of the invention, a computer program is provided. The computer program comprises instructions which, when the program is executed by the apparatus according to the above description, in particular by a processor of the apparatus, and/or by the system according to the above description, cause the apparatus and/or the system to perform the method according to the above description.

According to another aspect of the invention, a computer-readable storage medium is provided. The computer-readable storage medium may be, e.g., a CD-ROM, a USB stick or a hard drive, and comprises instructions which, when executed by the apparatus according to the above description and/or the system according to the above description, cause the apparatus and/or the system to perform the method according to the above description.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 shows a schematic view of a 3D printer and an embodiment of an apparatus for quality assessment;

FIG. 2 shows a flowchart of an embodiment of a computer-implemented method for quality assessment;

FIG. 3 show a flowchart of another embodiment of a computer-implemented method for quality assessment; and

FIG. 4 shows a schematic view of a print farm and an embodiment of a system for quality assessment.

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF EMBODIMENTS

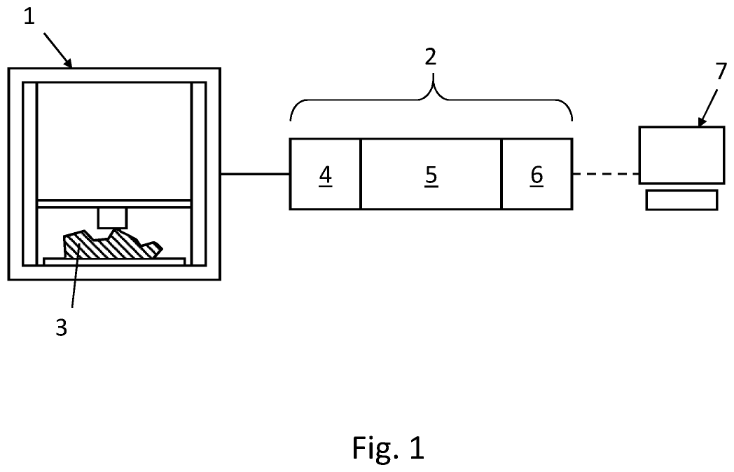

FIG. 1 shows a schematic view of a 3D printer 1 and an apparatus 2 for quality assessment of an object 3 produced by the 3D printer 1. The 3D printer 1 may use any kind of 3D printing process, in particular material extrusion, particle deposition, light polymerized printing, powder bed printing, laminated object manufacturing, powder fed printing or electron beam fabrication.

The 3D printer 1 is connected to the apparatus 2 for quality assessment of the object 3 produced by the 3D printer 1. The apparatus 2 comprises an input unit 4, a processing unit 5 and an output unit 6.

The input unit 4 is configured to receive input data of at least one production parameter pertaining to the production of the object 3. In particular, the input unit 4 will receive many production parameters. Said production parameters may comprise material parameters, environmental parameters and printing parameters. Material parameters are, e.g., the composition of the raw materials and/or specific material properties of the raw materials such as melting temperature, density, color or stiffness. Environmental parameters may comprise the environmental temperature, the air pressure, humidity and/or atmosphere composition. The printing parameters may comprise the version of the software installed on the 3D printer 1, the date of the last calibration, the date of the last service, the time, temperatures, e.g., at the printing head, feed speed, adjustment speed, reconstruction speed, retraction way, height of the printing layer and/or density of the printing layer.

In FIG. 1, the input unit 4 is directly connected to the 3D printer 1. Alternatively, the input unit 4 may be a network interface receiving the input data via a wired or wireless network connection.

The processing unit 5 comprises at least one processor, which is not shown here for the sake of clarity. It is configured to compare the at least one production parameter received by the input unit 4 to at least one predefined demanded production parameter range. The predefined demanded production parameter range may be defined manually based on parameter ranges known to produce printed objects 3 fulfilling required specifications. Additionally or alternatively, the predefined demanded production parameter range may be defined by machine learning techniques. The predefined demanded production parameter range may be given for each parameter separately but may also be a higher-dimensional range, taking into account a correlation between certain production parameters.

The processing unit 5 is further configured to determine the printing quality, based on the degree of agreement between the at least one production parameter received by the input unit 4 and the at least one predefined demanded production parameter range.

The output unit 6 receives the quality assessment from the processing unit 5 and is configured to provide said quality assessment results. In the embodiment of FIG. 1, the output unit 6 is a network interface, adapted to broadcast the quality assessment results to a computer 7, which may be located close to the apparatus 2 or at a remote location. The broadcasting may be performed via a wired and/or a wireless network connection. Alternatively, the output unit may be a graphical user interface, e.g., directly at the 3D printer 1.

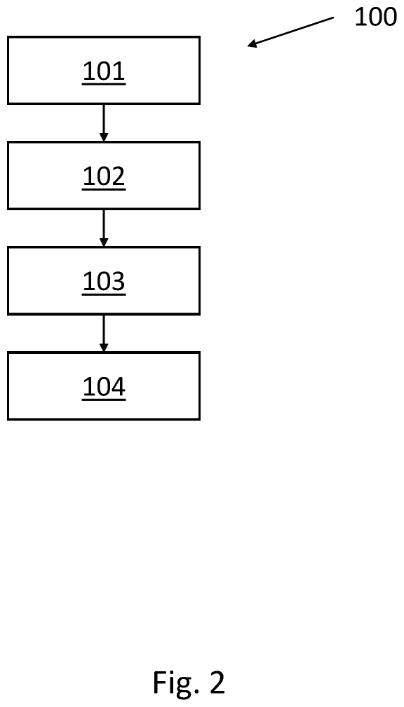

A flowchart of an embodiment of a computer-implemented method 100 that may be carried out by the apparatus 2 is shown in FIG. 2. As a first step, input data of the at least one production parameter is received 101, in particular via the input unit 4. The received at least one production parameter is then compared 102 to the at least one predefined demanded production parameter, in particular via the processing unit 5. Based on the degree of agreement between the at least one production parameter and the at least one predefined demanded production parameter range, the printing quality is determined 103, in particular via the processing unit 5.

Finally, the quality assessment results of the object 3 are provided 104, in particular via the output unit 6.

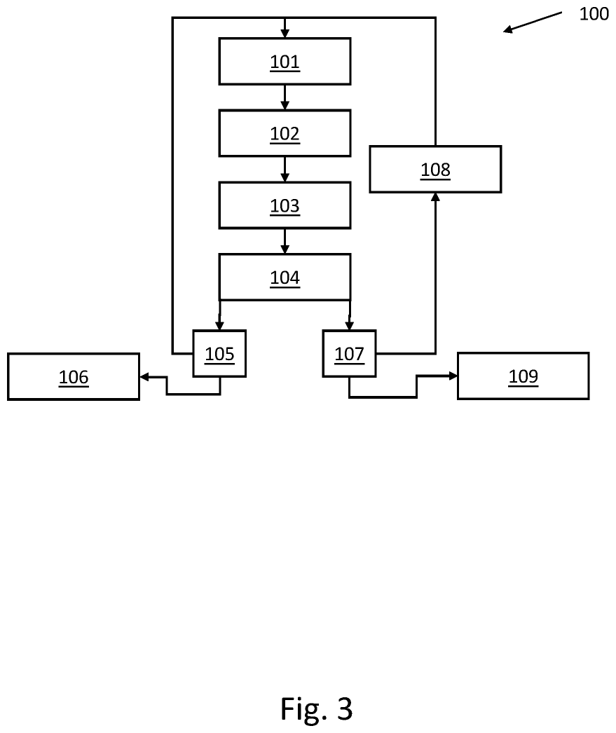

A flowchart of another, more elaborate, embodiment of a computer-implemented method 100 that may be carried out by the apparatus 2 is shown in FIG. 3. If the quality assessment results that have been provided 104 show that the printed object 3 is in agreement 105 with the required specifications, printing of the object 3 is continued. In particular, further input data is received 101 as the print of the object 3 progresses. At the end of the 3D print, the object 3 is marked 106 with a unique identifier if the quality assessment results are in agreement 105 with the required specifications. The unique identifier may be a bar code or a QR code and may contain information about the quality assessment results and/or may be used to connect the object 3 to its at least one production parameter.

If, on the other hand, the quality assessment results that have been provided show that the printed object 3 is in disagreement 107 with the required specifications, there exist several options, depending, inter alia, on the degree of disagreement 107. If the disagreement 107 is such that it can be corrected by a calibration of the 3D printer 1 and if the part of the object 3 that has been printed so far has acceptable quality, a calibration 108 is performed on the 3D printer and the print is continued. Hence, the object 3 can be printed in agreement with the required specifications.

If, however, the disagreement 107 is such that it cannot be corrected by a calibration 108 of the 3D printer, the production of the object 3 is aborted 109 and the part of the object 3 that has been printed so far is discarded. In this case, 3D printer 1 time and raw materials are saved since the print of an object 3 that does not meet the required specifications is not completed.

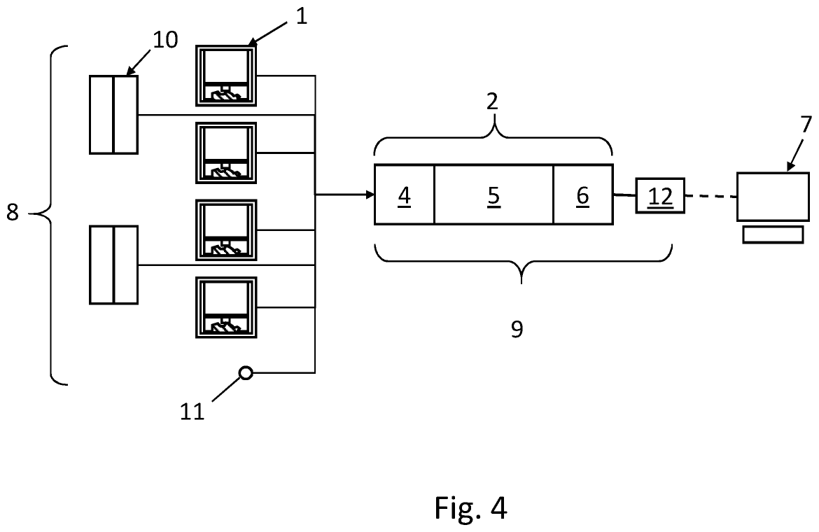

FIG. 4 shows a schematic view of a print farm 8 and an embodiment of a system 9 for quality assessment. The print farm 8 comprises a plurality of 3D printers 1 as well as cabinets 10 where raw materials for the 3D print are stored. Production parameters from the 3D printers and from the cabinets 10 are received by the input unit 4 of the apparatus 2. Also, other production parameters, such as environmental parameters collected by sensors 11 in the rooms of the print farm 8 may be received by the input unit 4. Examples for said sensors 11 are oxygen sensors, temperature sensors, humidity sensors and/or cameras, wherein the images captured by cameras may be processed by image recognition techniques.

The apparatus 2 is integrated in the system 9 for providing quality assessment of the objects 3 produced by the 3D printers 1. The system 9 further comprises a web server 12 that is configured to interface with a user, e.g., via the computer 7 of the user. In particular, the web server 12 provides a graphical user interface to the user which allows the user to access and control the quality of the objects 3 printed by the 3D printers 1 according to the user's order and/or specifications.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims. In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A computer-implemented method for quality assessment of an object produced by at least one 3D printer using 3D printing processes, the method comprising:
receiving input data of at least one production parameter pertaining to the production of the object;
comparing the received at least one production parameter to at least one predefined demanded production parameter range;
determining printing quality based on the degree of agreement between the at least one production parameter and the at least one predefined demanded production parameter range; and
providing quality assessment results of the object.

2. The computer-implemented method according to claim 1, further comprising
calibrating the at least one 3D printer based on the provided quality assessment results.

3. The computer-implemented method according to claim 1, further comprising
aborting the production of the object based on the provided quality assessment results.

4. The computer-implemented method according to claim 1, further comprising
inspecting the produced object based on the provided quality assessment results.

5. The computer-implemented method according to claim 1, further comprising
automatically rejecting the produced object based on the provided quality assessment results.

6. The computer-implemented method according to claim 1, wherein the at least one production parameter is at least one out of a group, the group comprising material parameters, environmental parameters and printing parameters.

7. The computer-implemented method according to claim 1, wherein the at least one production parameter is obtained during print execution and/or before print execution.

8. The computer-implemented method according to claim 1, wherein the at least one 3D printer is integrated in a print farm.

9. The computer-implemented method according to claim 1, wherein the object is marked based on the quality assessment results with a unique identifier.

10. The computer-implemented method according to claim 9, wherein the object is connected to its at least one production parameter using the unique identifier.

11. An apparatus for quality assessment of an object produced by at least one 3D printer using 3D printing processes, comprising:
an input unit;
a processing unit; and
an output unit,
wherein the input unit, the processing unit and the output unit are configured to carry out the method according to claim 1.

12. A system for providing quality assessment of an object produced by at least one 3D printer using 3D printing processes, comprising:
an apparatus according to claim 11; and
a web server configured to interface with a user,
wherein the system is configured to provide a graphical user interface to the user.

13. A computer program comprising instructions which, when the program is executed by one or both of an apparatus or a system, cause the apparatus or the system to perform the method according to claim 1.

14. A computer-readable storage medium comprising instructions which, when executed by one or both of an apparatus or a system, cause the apparatus or the system to perform the method according to claim 1.

15. The computer-implemented method according to claim 9, wherein the object is marked based on the quality assessment results with a bar code or a QR code.

16. The computer-implemented method according to claim 1, wherein the receiving of the input data is performed via an input unit.

17. The computer-implemented method according to claim 1, wherein the comparing the received at least one production parameter to the predefined demanded production parameter range is performed via a processing unit.

18. The computer-implemented method according to claim 1, wherein the determining of the printing quality based on the degree of agreement between the production parameter and the predefined demanded production parameter range is performed via a processing unit.

19. The computer-implemented method according to claim 1, wherein the providing of the quality assessment results of the object is performed via an output unit.

20. The apparatus according to claim 11, wherein the processing unit comprises at least one processor.

21. The system according to claim 12, wherein the web server is configured to interface with a user via one or both of a webpage served by the web server or via an application program.

22. The system according to claim 12, wherein the system is configured to provide the graphical user interface to the user by one or both of a webpage or an application program.

23. The computer program according to claim 13, wherein the program is executed by a processor of the apparatus.
